(19) United States
(12) Patent Application Publication
(10) Pub. No.: US 2026/0087444 A1
(43) Pub. Date: Mar. 26, 2026

(54) METHOD AND SYSTEM FOR OPTIMIZING LAST-MILE PRODUCT DELIVERY USING CROWD-SOURCED DELIVERY-SERVICE PROVIDERS

(71) Applicant: Cmile Inc., Westborough, MA (US)

(72) Inventors: Eugene Amigud, Hopinton, MA (US); Omar Akilah, Westborough, MA (US); Balaji Natarajan, Shrewsbury, MA (US)

(21) Appl. No.: 19/010,368

(22) Filed: Jan. 6, 2025

Related U.S. Application Data
(60) Provisional application No. 63/697,009, filed on Sep. 20, 2024.

(51) Int. Cl. G06Q 10/0835; G06Q 10/047; G06Q 10/0631; G06Q 10/0639; G06Q 10/0832; G06Q 10/0833

(52) U.S. Cl. CPC G06Q 10/08355; G06Q 10/047; G06Q 10/06315; G06Q 10/06398; G06Q 10/0832; G06Q 10/0833

(57) ABSTRACT

A method and system for last-mile product delivery is disclosed. The system allows each delivery-service provider of a platform of crowd-sourced delivery-service providers, to register vehicle specifications and delivery preferences including maximum delivery per trip. The system receives delivery orders within a predetermined time window, and dynamically determines delivery regions based on real-time factors of the delivery orders. Compatibility scores are determined by matching product handling requirements of the delivery orders with registered vehicle specifications. Multiple sequential delivery tours for individual delivery-service providers are generated within the single time window based on delivery-service provider specified maximum deliveries per trip, the compatibility scores, and the dynamically determined delivery regions. Finally, delivery assignments to the selected delivery-service providers are triggered based on the generated delivery tours.

### CROSS-REFERENCE TO PRIOR APPLICATION

This application claims the benefit of and priority to U.S. Provisional Application No. 63/697,009, filed on Sep. 20, 2024, which is hereby incorporated herein by reference in its entirety.

The entire contents of the priority application, including any appendices, exhibits, and amendments filed therewith, are hereby incorporated by reference in its entirety.

### FIELD

Various embodiments of the present disclosure generally relate to delivery of products. More particularly, the disclosure relates to a method and system for optimizing last-mile product delivery using crowd-sourced delivery-service providers.

### BACKGROUND

The e-commerce industry has seen tremendous growth over the past decade, with home delivery emerging as a key feature in modern customer-centric order management systems. Consumers expect quick, reliable deliveries irrespective of the sourcing location, be it a store, warehouse, or a third-party supplier. Various fulfillment models, including same-day, next-day, and express deliveries, have become common, driven by customer demand for convenience and speed. In this competitive environment, businesses are striving to offer seamless home delivery options while managing costs and maintaining operational efficiency.

While home delivery is a must-have feature, fulfilling these expectations presents significant challenges. The high costs associated with delivery, such as picking, packing, inventory handling, and transportation, pose financial strains on businesses. Companies either absorb these costs or pass them on to customers in the form of shipping fees. Furthermore, fulfilling delivery promises within tight timelines adds further pressure on businesses, especially during peak times or in cases of limited availability of physical resources, such as vehicles and delivery personnel.

Additionally, fulfilling delivery promises according to customer preferences, such as delivering on a specific date or time, requires careful planning. Companies must balance cost efficiency with the need to meet delivery commitments. Failing to meet delivery expectations can result in a loss of customer loyalty, negatively impacting business performance.

Various fulfillment optimization solutions are available to help businesses address some of these challenges. For instance, many companies use advanced sourcing algorithms to allocate orders to the nearest inventory locations, thereby reducing transportation costs and improving delivery speed. Some systems employ order consolidation techniques, combining multiple orders into a single shipment for delivery to a shared geographical area, which helps to optimize resources and reduce shipping expenses.

Order management systems also consider customer preferences during order capture and modification stages, presenting a range of fulfillment options, such as free delivery, express delivery, or scheduled pickups, based on feasibility and cost. Predictive systems have been developed to anticipate demand for products in certain regions, allowing companies to stock inventory more efficiently and plan their delivery routes accordingly. These solutions, while useful, still face limitations in addressing critical issues, especially in terms of resource constraints and serviceability in remote regions.

Despite the advancements in sourcing and fulfillment technologies, businesses continue to experience substantial pain points. A significant number of orders are not fulfilled due to resource limitations, such as the lack of available vehicles or delivery personnel. This often results in missed sales opportunities, particularly when customers request urgent deliveries, like same-day or two-hour windows, and no resources are available to meet the demand.

Moreover, servicing remote or less accessible regions remains a challenge. Businesses either compromise on profit margins to fulfill these orders or forgo them entirely, resulting in lost customers. The high operational costs involved in maintaining serviceability across all regions, especially for fast delivery options, make it difficult to provide consistent, cost-effective solutions.

Considering the aforementioned challenges, there is a requirement for a method and system that addresses the challenges of cost-effective and efficient order fulfilment while ensuring timely delivery, meeting customer preferences, and optimizing resource utilization, particularly in scenarios where existing conventional delivery models face limitations.

### SUMMARY

The present disclosure provides a method and system for last-mile product delivery. The system allows each delivery-service provider of a platform of crowd-sourced delivery-service providers, to register vehicle specifications and delivery preferences including maximum delivery per trip. The system receives delivery orders within a predetermined time window, and dynamically determines delivery regions based on real-time factors of the delivery orders. Compatibility scores are determined by matching product handling requirements of the delivery orders with registered vehicle specifications. Multiple sequential delivery tours for individual delivery-service providers are generated within the single time window based on delivery-service provider specified maximum deliveries per trip, the compatibility scores, and the dynamically determined delivery regions. Finally, delivery assignments to the selected delivery-service providers are triggered based on the generated delivery tours.

These and other features and advantages of the present disclosure may be appreciated from a review of the following detailed description of the present disclosure, along with the accompanying figures in which like reference numerals refer to like parts throughout.

### BRIEF DESCRIPTION OF THE FIGURES

FIG. 1 is a diagram that illustrates an exemplary environment within which various embodiments of the present disclosure may function.

FIG. 2 is a diagram that illustrates a system for dynamic last-mile delivery optimization, in accordance with an embodiment of the disclosure.

FIG. 3 is a diagram that illustrates a flow chart for a method for dynamic last-mile delivery optimization, in accordance with an embodiment of the disclosure.

### DESCRIPTION

Pursuant to various embodiments, the method and system enables last-mile product delivery by allowing each delivery-service provider of a platform of crowd-sourced delivery-service providers, to register vehicle specifications and delivery preferences including maximum delivery per trip. The system receives delivery orders within a predetermined time window, and dynamically determines delivery regions based on real-time factors of the delivery orders. Compatibility scores are determined by matching product handling requirements of the delivery orders with registered vehicle specifications. Multiple sequential delivery tours for individual delivery-service providers are generated within the single time window based on delivery-service provider specified maximum deliveries per trip, the compatibility scores, and the dynamically determined delivery regions. Finally, delivery assignments to the selected delivery-service providers are triggered based on the generated delivery tours.

In one or more embodiments, products may refer to any tangible or intangible item that is ordered by customers. The products could include physical goods, such as electronics, clothing, groceries, or furniture, as well as digital goods or services, such as software, subscriptions, or maintenance services. Each product may have associated attributes, such as size, weight, value, and delivery requirements, which the system considers when processing the order.

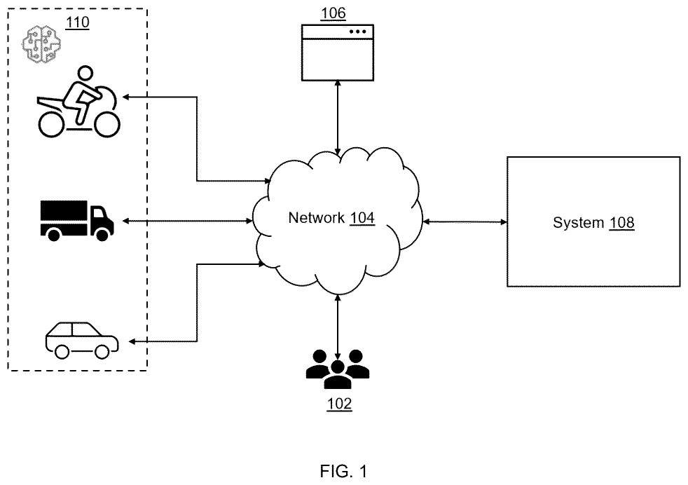

FIG. 1 is a diagram that illustrates an exemplary environment 100 within which various embodiments of the present disclosure may function. Referring to FIG. 1, the environment 100 may comprise one or more customers 102, a network 104, a website 106, a system 108, a platform 110 of one or more service providers.

The one or more customers 102 can be individuals or entities who place orders for products or services through an online portal. The one or more customers 102 can stay at any location to place their orders, as the system 108 is designed to facilitate remote order placement through the website 106, enabling the one or more customers 102 to access the platform from virtually any geographic location.

The network 104 includes communication networks operable to facilitate communication, either wirelessly or wired. The network 106 connects a plurality of computer systems. The network 106 may comprise, for example, an intranet, local area network, wide area network, the internet, public switched telephone network (PSTN), network of networks, or other network.

The website 106 can be at least one of an online platform, an application, an internet enabled user interface, and a portal that enables the one or more customers 102 to browse, select, and purchase products or services. It can be designed with a user-friendly interface and may support various features, such as personalized recommendations, order tracking, and secure payment options. Additionally, the user interface can be a voice-based user interface, enabling customers to interact through voice commands. For instance, customers could utilize virtual assistants to place orders, set preferences, or perform other actions seamlessly. The website 106 may also serve as a point of interaction for capturing preferences and feedback. The website 106 can also be accessible via multiple devices, including smartphones, tablets, and computers, ensuring seamless interaction from diverse locations.

In some non-limiting embodiments, users who can access to the website 106 can be both customers and customer service representatives. Customers may interact with the website 106 directly, while customer service representatives may utilize the user interface on behalf of the customers to assist with browsing, selecting, or purchasing products and services.

The system 108 combines demand forecasts for a specific neighborhood or small geographical area with delivery-service provider availability to consolidate multiple orders within that area into a single package. Once the package is handed over to a crowd-sourced delivery-service provider in the neighborhood, the system 108 confirms that the delivery-service provider follows an optimized route to deliver the individual packages to their respective addresses.

The platform 110 of crowd-sourced delivery-service providers refers to a decentralized network that connects individuals willing to perform delivery tasks with businesses or customers needing delivery services. The platform 110 typically leverages digital tools, such as a mobile application or website, to facilitate communication, assign tasks, and manage logistics. The crowd-sourced delivery providers of the platform 110 are independent delivery-service providers, using their own vehicles and resources to fulfill delivery assignments.

In one or more embodiments, the platform 110 of crowd-sourced delivery-service providers maintains a database of each delivery-service provider, which includes registered vehicle specifications such as type, size, and capacity, as well as the delivery preferences. The preferences may include parameters like the maximum number of deliveries they are willing to handle per trip, preferred delivery time slots, and geographical areas they are comfortable servicing.

In one or more embodiments, each delivery-service provider of the platform 110 is allowed to specify at least one delivery preference such as, but not limited to, specifying available time slots during which the delivery-service provider is willing to accept delivery assignments, such as morning, afternoon, or evening hours, or particular days of the week when they are available to perform deliveries.

In one or more embodiments, each delivery-service provider of the platform 110 can set a limit on the maximum number of deliveries they are willing to handle per trip. The limit helps avoid overloading the delivery-service provider and allow them to complete their assigned deliveries efficiently and within a reasonable time frame. The delivery-service providers may also specify preferred delivery locations, which can include particular geographic areas, neighborhoods, or specific delivery zones where they are comfortable or have familiarity with the routes.

In one or more embodiments, the platform 110 is also configured to allow delivery-service providers to define the types of items they are willing to deliver, taking into account item characteristics such as weight, size, and product category. For instance, a delivery-service provider may opt to handle only lightweight items, such as electronics or clothing, or may specialize in delivering bulkier or more fragile items, such as furniture or perishable goods.

In one or more embodiments, the platform 110 is further configured to continuously update vehicle specifications based on at least one of sensor data from delivery vehicles and validated delivery-service provider's performance. The sensor data, which may include real-time information such as vehicle speed, fuel consumption, location, and condition, is used to dynamically update the vehicle specifications stored in the platform 110.

In one or more embodiments, the database containing the delivery-service provider data can be any type of database, whether centralized or distributed, and can be located on any server or cloud infrastructure, accessible via the network 104. The database may be hosted on a local server, a private cloud, or a public cloud platform, depending on the system's architecture and scalability requirements. The platform 110 can access and update the database in real-time, ensuring that the most current information about each provider, including their vehicle specifications and delivery preferences, is available for efficient task allocation and delivery management.

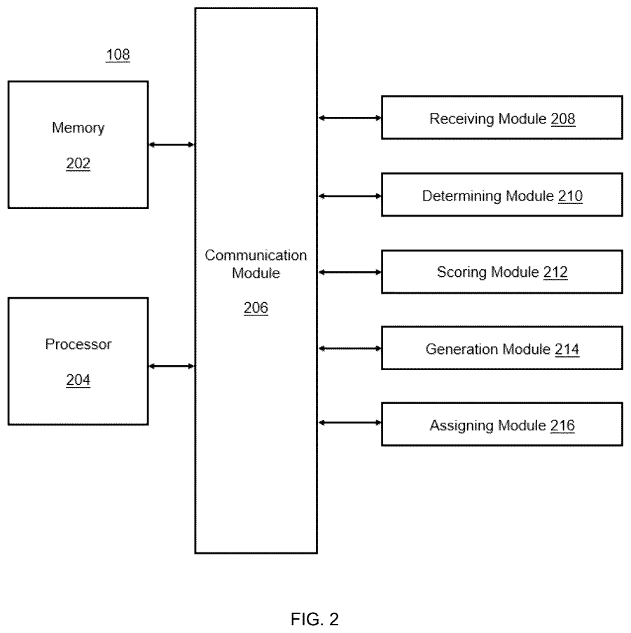

FIG. 2 is a diagram that illustrates the system 108 for dynamic last-mile delivery optimization, in accordance with an embodiment of the disclosure. Referring to FIG. 2, the system 108 comprises a memory 202, a processor 204, a communication module 206, a receiving module 208, a determining module 210, a scoring module 212, a generation module 214, and an assigning module 216.

The memory 202 may comprise suitable logic, and/or interfaces, that may be configured to store instructions (for example, computer-readable program code) that can implement various aspects of the present disclosure.

The processor 204 may comprise suitable logic, interfaces, and/or code that may be configured to execute the instructions stored in the memory 202 to implement various functionalities of the system 108 in accordance with various aspects of the present disclosure. The processor 204 may be further configured to communicate with various modules of the system 102 via the communication module 206.

The receiving module 208 may comprise suitable logic, code, and/or interfaces that may be configured to receive the delivery orders within a predetermined time window. The configuration confirms that only orders submitted within the specified timeframe are captured by the system 108 for further processing. The receiving module 208 is responsible for validating that each incoming order meets the time-based criteria before it is accepted into the workflow.

The determining module 210 may comprise suitable logic, code, and/or interfaces that may be configured to dynamically determine delivery regions based on the received delivery orders. The determining module 210 is configured to analyze the details of each order, such as the delivery address and customer preferences, and determining the geographical region to which the order belongs. The system 108 may use factors such as proximity, route efficiency, and available delivery-service providers to classify the orders into specific regions.

In one or more embodiments, the determining module 210 determines delivery regions by receiving a current location of a delivery-service provider which refers to the provider's precise position at any given moment, ensuring that deliveries are precisely assigned based on real-time data. The determining module 210 then generates a delivery region centered around the current location of the delivery-service provider independent of any fixed delivery routes, referring that the system 108 dynamically creates a geographical area for deliveries, adapting to the delivery-service provider's current whereabouts.

In one or more embodiments, the determining module 210 determines a radius of the delivery region based on a quantity of delivery orders within the predetermined time window, making the size of the delivery area is adjusted according to the volume of orders that need to be fulfilled, balancing the workload for the delivery-service provider.

In some non-limiting embodiments, the radius can range from any distance without any limitations. The radius is not constrained by predefined limits, allowing it to dynamically expand or contract to encompass the area required to meet the demand for deliveries.

In one or more embodiments, the determining module 210 modifies the radius of the delivery region upon changes in the quantity of delivery orders, making the delivery area to expand or contract as needed in response to variations in order demand.

The scoring module 212 may comprise suitable logic, code, and/or interfaces that may be configured to determine compatibility scores by matching product handling requirements of the delivery orders with registered vehicle specifications and delivery-service provider preferences. The scoring module 212 compares key factors such as the weight, size, and fragility of the items to be delivered with the capabilities of the registered vehicles, such as their load capacity, available storage space, and any special equipment (e.g., temperature control for perishable items or cushioning for fragile goods). Based on the evaluation, the scoring module 212 assigns a compatibility score to each delivery-service provider.

In one or more embodiments, determining compatibility scores by the scoring module 212 involves matching product requirements, including fragility, temperature sensitivity, and hazardous material indicators, with vehicle capabilities, including suspension characteristics, cargo space parameters, and temperature control features. The scoring module 212 may also assess how well the vehicle can accommodate specific product needs. For instance, fragility indicators are matched with the vehicle's suspension characteristics to confirm that fragile items are transported with minimal risk of damage due to road conditions. Temperature-sensitive items are compared with the vehicle's temperature control features, to confirm that perishable goods or items requiring specific temperature ranges are transported in optimal conditions. Hazardous material indicators are checked against the vehicle's cargo space parameters and safety features, to confirm that the vehicle complies with necessary regulations and is equipped to safely transport hazardous goods.

In one or more embodiments, determining compatibility score by the scoring module 212 further involves utilizing at least one of attribute matching techniques, semantic analysis, statistical models, and machine learning algorithms. Attribute matching techniques may be employed to directly compare the specific attributes of the product and vehicle, such as weight, size, and storage capacity, ensuring that both match within predefined thresholds. Semantic analysis may be used to understand and interpret more complex requirements, such as the fragility of a product or its temperature sensitivity, by analyzing textual descriptions and product metadata. Statistical models can be applied to predict the likelihood of a vehicle's suitability based on historical delivery performance data, providing a data-driven approach to evaluating compatibility. Additionally, machine learning algorithms can improve over time by learning from past deliveries, optimizing the compatibility scoring process by identifying patterns and correlations between product characteristics and vehicle capabilities.

In an exemplary embodiment, the attribute matching technique is a simple rule-based technique that is used to match product and vehicle attributes. For instance, if a delivery order requires a product weighing 50 kg and the registered vehicle has a cargo capacity of 100 kg, the scoring module 212 matches the product's weight with the vehicle's weight-bearing capacity.

In an exemplary embodiment, for temperature-sensitive products, the semantic analysis may analyze product descriptions such as “requires refrigeration” or “keep at 0-5° C.” to match those needs with a vehicle that has a refrigerated cargo area. Semantic analysis can also be used to interpret labels like “fragile” or “handle with care” in product descriptions to align with the vehicle's suspension and handling characteristics.

In an exemplary embodiment, statistical models are used to predict whether a vehicle is likely to successfully deliver a specific product type. The models are trained on historical delivery data (e.g., vehicle capacity, type of product, delivery success rate) to calculate the probability of a successful delivery, which is then used to generate compatibility scores.

In an exemplary embodiment, machine learning algorithms like a decision tree or random forest could be used to classify vehicles based on their suitability for specific product types. For instance, the model utilizes features such as the product's weight, size, temperature sensitivity, and fragility, alongside historical performance data, to assign compatibility scores.

The generation module 214 may comprise suitable logic, code, and/or interfaces that may be configured to generate multiple sequential delivery tours for individual delivery-service providers within the single time window based on delivery-service provider specified maximum deliveries per trip, the compatibility scores, and the dynamically determined delivery regions.

In one or more embodiments, generating multiple sequential delivery tours for individual delivery-service providers by the generation module 214 involves evaluating consolidated delivery orders based on the compatibility scores. The evaluation process enables grouping the delivery orders together in a way that maximizes the efficiency of each delivery tour. The compatibility scores indicate how well a delivery-service provider's vehicle can handle specific products based on factors like fragility, temperature sensitivity, and cargo space, play a crucial role in this process.

In one or more embodiments, generating multiple sequential delivery tours for individual delivery-service providers by the generation module 214 involves dividing compatible delivery orders into sequential tours based on the delivery-service provider preferences such as, specified maximum deliveries per trip or maximum weight per trip. Each delivery-service provider is assigned a manageable number of deliveries per tour, aligning with their stated capacity and preferences. By considering the maximum deliveries a delivery-service provider is willing or able to handle in a single trip, the generation module 214 optimizes the assignment of orders, ensuring that no delivery-service provider is overloaded while still fulfilling all delivery requirements within the time window. The division of orders into sequential tours indicates that each delivery route is logical, minimizing travel distance and time, while also prioritizing deliveries in an efficient manner.

In one or more embodiments, generating multiple sequential delivery tours for individual delivery-service providers by the generation module 214 involves scheduling subsequent tours after verifying completion of preceding delivery tours. By verifying that a preceding delivery tour is completed, the generation module 214 prevents overlapping or conflicting schedules, which could lead to delays or inefficiencies. The verification step may include tracking the status of deliveries, ensuring that all required deliveries have been made and confirming the delivery-service provider's availability for the next scheduled tour. Once the preceding tour is confirmed as completed, the generation module 214 schedules the next tour based on the remaining delivery orders and the delivery-service provider's preferences such as, specified maximum deliveries per trip, ensuring that the delivery-service provider's workload is balanced and manageable.

In one or more embodiments the generation module 214 generates multiple sequential delivery tours by determining a required number of sequential tours based on a total number of delivery orders and the delivery-service provider specified maximum deliveries per trip, scheduling the sequential tours within the predetermined time window, and verifying completion of a preceding tour before initiating a subsequent tour.

In one or more embodiments, the generation module 214 constantly monitors real-time changes in delivery order density within the dynamically determined delivery regions, and adjusts boundaries of the delivery regions based on the real-time changes. As delivery orders are received and their locations tracked, the generation module 214 continuously analyzes the concentration of orders within specific geographical areas. When there is an increase or decrease in order density, the generation module 214 responds by adjusting the boundaries of the delivery regions to more accurately reflect the current demand. For instance, if a particular area experiences a surge in orders, the delivery region boundary may be expanded to encompass the higher order volume, or if demand drops, the boundaries could be contracted to avoid underutilizing resources.

As the delivery regions are adjusted in real-time, the generation module 214 updates the multiple sequential delivery tours that are planned for the delivery-service providers by recalculating the optimal delivery routes and schedules to account for the changes in the geographical distribution of orders.

In one or more embodiments, the generation module 214 calculates how many tours are needed by dividing the total number of delivery orders by the maximum deliveries a delivery-service provider is willing or able to handle per trip. Once the number of required tours is determined, the generation module 216 schedules the tours within the available time window, optimizing the delivery sequence to ensure timely completion of all deliveries. After scheduling the tours, the generation module 216 tracks the progress of each tour, confirming that the delivery-service provider has completed a preceding tour before scheduling or initiating the next one.

The assigning module 216 may comprise suitable logic, code, and/or interfaces that may be configured to trigger delivery assignments to the selected delivery-service providers based on the generated delivery tours. The assigning module 216 evaluates the generated delivery tours, taking into account factors such as the delivery-service provider's availability, vehicle specifications, and delivery preferences. Based on the evaluation, the assigning module 216 assigns the corresponding orders to each delivery-service provider allowing them with the appropriate set of deliveries that align with their capabilities and preferences.

In one or more embodiments, upon triggering delivery assignments, the orders associated with the assigned deliveries are first delivered to the delivery-service provider, enabling them to commence delivering the orders to the respective customers.

In some non-limiting embodiments, the orders may be delivered to the registered address of the delivery-service provider. Alternatively, the orders may be delivered to the delivery-service provider's current location to facilitate immediate and flexible delivery operations.

In one or more embodiments, the assigning module 216 is further configured to forecast future delivery demand based on historical order data, and dynamically adjust delivery assignments based on current order density and availability of delivery service-providers. The process begins by analyzing historical order data, including past delivery volumes, order patterns, seasonal trends, and geographic distribution of deliveries. By identifying the patterns, the assigning module 216 can predict areas with likely higher demand or times when more deliveries will be needed.

In one or more embodiments, once the forecast is generated, the assigning module 216 continuously monitors real-time data on order density, which indicates the concentration of delivery requests in specific locations or time windows. Based on the density of these orders, the assigning module 216 dynamically adjusts the assignment of deliveries to delivery-service providers. For example, if an area experiences a sudden increase in orders or higher density, the assigning module 216 can allocate more delivery-service providers to that region to handle the surge, ensuring timely deliveries. Similarly, if there are fewer orders in a particular area, the assigning module 216 can redistribute available delivery-service providers to other areas with greater demand, optimizing the use of available resources. Additionally, the assigning module 216 takes into account the real-time availability of delivery-service providers, considering factors such as their proximity to orders, current workloads, and the specifications of their vehicles.

In one or more embodiments, the assigning module 216 is configured to receive real-time delivery updates, and track fulfilment progress to dynamically reassign incomplete deliveries based on compatibility scores. As deliveries progress, the assigning module 216 continuously monitors updates, such as changes in the status of individual orders, delays, or issues encountered by delivery-service providers.

In one or more embodiments, if any delivery is delayed or remains incomplete due to factors such as traffic, vehicle breakdowns, or the delivery-service provider's inability to fulfill specific requirements, the assigning module 216 receives the real-time updates and evaluates whether the delivery can be completed within the specified time window. Else, the assigning module 216 can identify alternative delivery-service providers who are better equipped to handle the remaining deliveries, based on their vehicle specifications, location, and available capacity.

To make informed reassignment decisions, the module leverages compatibility scores that reflect how well a particular delivery-service provider's vehicle and capabilities match the requirements of the pending deliveries. For example, if a delivery involves a fragile item or a temperature-sensitive product, the system 108 confirms that the reassigned delivery is allocated to a delivery-service provider whose vehicle is capable of handling such items. By dynamically adjusting assignments based on compatibility, the assigning module ensures that deliveries are completed efficiently and within the required timeframe, minimizing disruptions and maintaining high levels of customer satisfaction.

In one or more embodiments, when the system 108 receives a rejection response from a selected delivery-service provider, it identifies alternative delivery-service providers based on the compatibility scores and triggers the assigning module 216 to reassign the rejected sequential delivery tours to maintain delivery schedules. If a selected delivery-service provider is unable to fulfill the assigned deliveries due to one or more reasons sch as, vehicle unavailability, scheduling conflicts, etc. the system 108 responds by quickly assessing alternative delivery-service providers who are best suited to take over the delivery tasks.

In one or more embodiments, the system 108 enables the service providers to conveniently accept and manage delivery tours through mobile notifications, providing a streamlined and user-friendly interface for engagement. When a delivery tour is generated and assigned, the delivery-service providers receive notifications via their registered mobile devices, which include details such as the delivery region, number of stops, estimated delivery time, and any specific handling requirements.

In one or more embodiments, the system 108 utilizes compatibility scores, which have been precomputed to reflect how well a delivery-service provider's vehicle and available capabilities align with the requirements of the delivery orders. The compatibility scores account for factors such as the vehicle's capacity, ability to handle specific product types (e.g., fragile, temperature-sensitive, or large items), and geographical proximity to the delivery location.

In one or more embodiments, once alternative delivery-service providers are identified, the assigning module 216 is triggered to reassigns the rejected sequential delivery tours to the delivery-service providers. The system 108 may reassign the rejected sequential delivery tours dynamically, prioritizing the need to maintain delivery schedules and meet customer expectations.

In one or more embodiments, the system 108 is configured to validate delivery-service provider performance based on at least one of adherence to product handling requirements and maintaining compatibility scores above a threshold. The system 108 continuously monitors the performance of delivery-service providers by assessing how well they meet the specified criteria for handling products, such as ensuring that items are transported under the correct conditions (e.g., temperature control for sensitive items, proper care for fragile products, etc.).

In addition to evaluating adherence to product handling requirements, the system 108 also tracks the performance of each delivery-service provider by ensuring that their compatibility scores remain above a predefined threshold. The scores are determined based on how well the delivery-service provider's vehicle specifications and capabilities align with the specific needs of the delivery orders, such as weight capacity, size, temperature control features, and other relevant attributes.

In one or more embodiments, by maintaining compatibility scores above the threshold, the system 108 ensures that only those delivery-service providers who consistently meet the necessary standards are retained for future delivery assignments. Delivery-service providers who fail to maintain a satisfactory performance level, either by not adhering to product handling requirements or by falling below the compatibility score threshold, may be flagged for review or temporarily removed from the pool of available delivery-service providers.

In one or more embodiments, the system 108 is also configured to predict regional delivery demand for upcoming periods, prioritize immediate delivery orders while temporarily holding remaining delivery orders, and consolidate the held delivery orders with future predicted demand. Using one or more forecasting techniques, the system 108 analyzes historical order data, seasonal trends, and real-time inputs to predict delivery demand for specific regions in forthcoming time periods. This predictive capability enables the system 108 to allocate resources more effectively and plan delivery tours in advance.

In some non-limiting embodiments, the one or more forecasting techniques can be statistical models, machine learning algorithms, or hybrid approaches that combine multiple methodologies to enhance prediction accuracy. Statistical models may include time-series analysis techniques such as autoregressive integrated moving average (ARIMA), exponential smoothing state space models (ETS), or seasonal decomposition of time series (STL) to identify patterns and trends in historical order data.

For immediate delivery orders that require urgent attention, the system 108 may prioritize their processing and ensures they are assigned to available delivery-service providers within the predetermined time window. Simultaneously, the system 108 identifies non-urgent orders and temporarily holds them in the system's 108 queue. The held orders are not assigned for immediate delivery but are instead consolidated with predicted demand for future periods.

In one or more embodiments, consolidating the held delivery orders may involve a multi-step process designed to enable efficient and accurate delivery scheduling. Initially, the system 108 evaluates the availability data of delivery-service providers to identify who are free or have capacity to accommodate additional delivery assignments. The evaluation may include checking the time slots in which each delivery-service provider is available, their maximum delivery capacity, and their geographical preferences for delivering orders.

In one or more embodiments, once the delivery-service provider availability is assessed, the system 108 proceeds to group the held delivery orders based on dynamically determined delivery regions. The regions are defined in real-time, considering factors such as the density of delivery orders in a specific area, the locations of the customers, and the proximity of available delivery-service providers. Grouping orders by region ensures that the deliveries are geographically clustered, reducing travel time and optimizing the use of resources.

Further, the system 108 optimizes the consolidated delivery assignments by evaluating the compatibility scores for each delivery-service provider and their associated delivery orders. The compatibility scores are determined by matching the product requirements, such as weight, fragility, or special handling needs, with the specifications and capabilities of the delivery vehicles registered by the delivery-service providers.

### Exemplary Scenario:

Consider an exemplary embodiment demonstrating the process of last-mile product delivery using crowd-sourced delivery-service providers.

The process begins with the receiving module 208, which receives 150 delivery orders within the predetermined time window. The orders are recorded in the system 108, along with their specific product handling requirements, delivery addresses, and requested delivery times.

For instance, an order for perishable goods requires refrigeration during transit, while a television order demands careful handling due to fragility.

The determining module 210 analyzes the received orders and the real-time availability of delivery-service providers.

For example, it dynamically calculates three delivery regions across the city-North, Central, and South—by clustering delivery addresses based on their proximity. For example, the North region may include 50 orders concentrated in residential neighborhoods, while the Central region comprises 70 orders near commercial hubs.

The determining module 210 determines the radius of each region by balancing the quantity of delivery orders and the availability of delivery-service providers. As new orders are received or canceled, the delivery region boundaries are adjusted in real-time.

The scoring module 212 evaluates compatibility scores by matching each order's product requirements with delivery-service provider preferences and the specifications of registered delivery vehicles. For example:
A refrigerated van with temperature control is assigned a high compatibility score for grocery orders.
A van with advanced suspension is rated highly for electronic items requiring minimal vibration during transit.

In an exemplary embodiment, based on the preferences, a delivery-service provider may choose not to use a vehicle for all the deliveries. For instance, a registered delivery-service provider may choose to personally walk to the customers' houses in a street to complete the deliveries, which might also help achieve daily walking-step goal. Similarly, even if the delivery-service provider's registered vehicle is equipped with refrigeration capabilities, the delivery-service provider may opt out of handling or delivering temperature-sensitive items, based on their personal preferences or limitations.

This enables optimal matching of orders to delivery-service provider vehicles, enhancing delivery quality and reducing risks of product damage.

The generation module 214 generates sequential delivery tours for delivery-service providers based on compatibility scores and dynamically determined delivery regions. For instance:
A provider in the North region, with a maximum capacity of 20 deliveries per trip, is assigned two sequential tours: one for perishable groceries and another for miscellaneous items.
In the Central region, a provider with higher capacity is assigned three tours, prioritizing time-sensitive deliveries first.

The assigning module 216 triggers notifications to delivery-service providers through their mobile devices. Each delivery-service provider receives the details of their assigned tours, including delivery addresses, estimated travel time, and specific handling instructions. For instance:
A provider in the South region is notified about a tour comprising 15 deliveries of electronics. Upon rejection of this tour by the initial provider due to unforeseen circumstances, the assigning module 216 identifies an alternative provider with a compatible vehicle and reassigns the tour.

Throughout the process, the system 108 continuously tracks real-time updates from delivery-service providers via GPS and mobile notifications. If a delivery is delayed or a delivery-service provider fails to complete a tour, the system 108 dynamically reassigns pending deliveries to other available delivery-service providers, ensuring minimal disruption to the schedule.

Outcome: By the end of the time window, all 150 orders are successfully delivered. The integration of the modules ensures that each order is matched with the right delivery-service provider, delivery regions are optimized, and the overall operation is both cost-efficient and reliable.

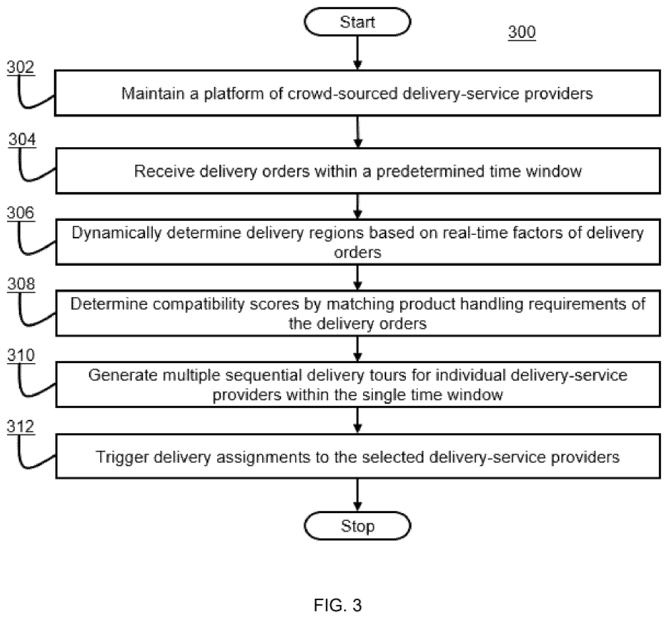

FIG. 3 is a diagram that illustrates a flow chart 300 for a method for dynamic last-mile delivery optimization, in accordance with an embodiment of the disclosure.

At 302, the system 108 maintains the platform 110 of crowd-sourced delivery-service providers, each delivery-service provider having registered vehicle specifications and delivery preferences including maximum delivery per trip.

In one or more embodiments, the platform 110 of crowd-sourced delivery-service providers maintains a database of each delivery-service provider, which includes registered vehicle specifications such as type, size, and capacity, as well as the delivery-service provider's delivery preferences. The preferences may include parameters like the maximum number of deliveries they are willing to handle per trip, preferred delivery time slots, and geographical areas they are comfortable servicing.

In one or more embodiments, each delivery-service provider of the platform 110 is allowed to specify at least one delivery preference such as, but not limited to, specifying available time slots during which the delivery-service provider is willing to accept delivery assignments, such as morning, afternoon, or evening hours, or particular days of the week when they are available to perform deliveries.

At 304, the receiving module 208 receives delivery orders within a predetermined time window. The configuration confirms that only orders submitted within the specified timeframe are captured by the system 108 for further processing. The receiving module 208 is responsible for validating that each incoming order meets the time-based criteria before it is accepted into the workflow.

At 306, the determining module 210 dynamically determines delivery regions based on real-time factors of delivery orders. The determining module 210 is configured to analyze the details of each order, such as the delivery address and customer preferences, and determining the geographical region to which the order belongs. The system 108 may use factors such as proximity, route efficiency, and available delivery-service providers to classify the orders into specific regions.

In one or more embodiments, the determining module 210 determines delivery regions by receiving a current location of a delivery-service provider which refers to the delivery-service provider's precise position at any given moment, ensuring that deliveries are precisely assigned based on real-time data. The determining module 210 then generates a delivery region centered around the current location of the delivery-service provider independent of any fixed delivery routes, referring that the system 108 dynamically creates a geographical area for deliveries, adapting to the delivery-service provider's current whereabouts.

In one or more embodiments, the determining module 210 determines a radius of the delivery region based on a quantity of delivery orders within the predetermined time window, making the size of the delivery area is adjusted according to the volume of orders that need to be fulfilled, balancing the workload for the delivery-service provider.

At 308, the scoring module 212 determines compatibility scores by matching product handling requirements of the delivery orders with registered vehicle specifications and delivery-service provider preferences. The scoring module 212 compares key factors such as the weight, size, and fragility of the items to be delivered with the capabilities of the registered vehicles, such as their load capacity, available storage space, and any special equipment (e.g., temperature control for perishable items or cushioning for fragile goods). Based on the evaluation, the scoring module 212 assigns a compatibility score to each delivery-service provider.

In one or more embodiments, determining compatibility scores by the scoring module 212 involves matching product requirements, including fragility, temperature sensitivity, and hazardous material indicators, with vehicle capabilities, including suspension characteristics, cargo space parameters, and temperature control features. The scoring module 212 may also assess how well the vehicle can accommodate specific product needs. For instance, fragility indicators are matched with the vehicle's suspension characteristics to confirm that fragile items are transported with minimal risk of damage due to road conditions. Temperature-sensitive items are compared with the vehicle's temperature control features, to confirm that perishable goods or items requiring specific temperature ranges are transported in optimal conditions. Hazardous material indicators are checked against the vehicle's cargo space parameters and safety features, to confirm that the vehicle complies with necessary regulations and is equipped to safely transport hazardous goods.

In one or more embodiments, determining compatibility score by the scoring module 212 further involves utilizing at least one of attribute matching techniques, semantic analysis, statistical models, and machine learning algorithms. Attribute matching techniques may be employed to directly compare the specific attributes of the product and vehicle, such as weight, size, and storage capacity, ensuring that both match within predefined thresholds. Semantic analysis may be used to understand and interpret more complex requirements, such as the fragility of a product or its temperature sensitivity, by analyzing textual descriptions and product metadata. Statistical models can be applied to predict the likelihood of a vehicle's suitability based on historical delivery performance data, providing a data-driven approach to evaluating compatibility. Additionally, machine learning algorithms can improve over time by learning from past deliveries, optimizing the compatibility scoring process by identifying patterns and correlations between product characteristics and vehicle capabilities.

At 310, the generation module 214 generates multiple sequential delivery tours for individual delivery-service providers within the single time window based on delivery-service provider specified maximum deliveries per trip, the compatibility scores, and the dynamically determined delivery regions.

In one or more embodiments, generating multiple sequential delivery tours for individual delivery-service providers by the generation module 214 involves evaluating consolidated delivery orders based on the compatibility scores. The evaluation process enables grouping the delivery orders together in a way that maximizes the efficiency of each delivery tour. The compatibility scores indicate how well a delivery-service provider's vehicle can handle specific products based on factors like fragility, temperature sensitivity, and cargo space, play a crucial role in this process.

In one or more embodiments, generating multiple sequential delivery tours for individual delivery-service providers by the generation module 214 involves dividing compatible delivery orders into sequential tours based on the delivery-service provider preferences such as, specified maximum deliveries per trip or maximum weight per trip. Each delivery-service provider is assigned a manageable number of deliveries per tour, aligning with their stated capacity and preferences. By considering the maximum deliveries a delivery-service provider is willing or able to handle in a single trip, the generation module 214 optimizes the assignment of orders, ensuring that no delivery-service provider is overloaded while still fulfilling all delivery requirements within the time window. The division of orders into sequential tours indicates that each delivery route is logical, minimizing travel distance and time, while also prioritizing deliveries in an efficient manner.

In one or more embodiments, generating multiple sequential delivery tours for individual delivery-service providers by the generation module 214 involves scheduling subsequent tours after verifying completion of preceding delivery tours. By verifying that a preceding delivery tour is completed, the generation module 214 prevents overlapping or conflicting schedules, which could lead to delays or inefficiencies. The verification step may include tracking the status of deliveries, ensuring that all required deliveries have been made and confirming the delivery-service provider's availability for the next scheduled tour. Once the preceding tour is confirmed as completed, the generation module 214 schedules the next tour based on the remaining delivery orders and the delivery-service provider's preferences such as, specified maximum deliveries per trip, ensuring that the delivery-service provider's workload is balanced and manageable.

In one or more embodiments the generation module 214 generates multiple sequential delivery tours by determining a required number of sequential tours based on a total number of delivery orders and the delivery-service provider specified maximum deliveries per trip, scheduling the sequential tours within the predetermined time window, and verifying completion of a preceding tour before initiating a subsequent tour.

At 312, the assigning module 216 triggers delivery assignments to the selected delivery-service providers based on the generated delivery tours. The assigning module 216 evaluates the generated delivery tours, taking into account factors such as the delivery-service provider's availability, vehicle specifications, and delivery preferences. Based on the evaluation, the assigning module 216 assigns the corresponding orders allowing each delivery-service provider with the appropriate set of deliveries that align with their capabilities and preferences.

In one or more embodiments, upon triggering delivery assignments, the orders associated with the assigned deliveries are first delivered to the delivery-service provider, enabling them to commence delivering the orders to the respective customers.

In one or more embodiments, the assigning module 216 is further configured to forecast future delivery demand based on historical order data, and dynamically adjust delivery assignments based on current order density and availability of delivery service-providers. The process begins by analyzing historical order data, including past delivery volumes, order patterns, seasonal trends, and geographic distribution of deliveries. By identifying the patterns, the assigning module 216 can predict areas with likely higher demand or times when more deliveries will be needed.

In one or more embodiments, once the forecast is generated, the assigning module 216 continuously monitors real-time data on order density, which indicates the concentration of delivery requests in specific locations or time windows. Based on the density of these orders, the assigning module 216 dynamically adjusts the assignment of deliveries to delivery-service providers. For example, if an area experiences a sudden increase in orders or higher density, the assigning module 216 can allocate more delivery-service providers to that region to handle the surge, ensuring timely deliveries. Similarly, if there are fewer orders in a particular area, the assigning module 216 can redistribute available delivery-service providers to other areas with greater demand, optimizing the use of available resources. Additionally, the assigning module 216 takes into account the real-time availability of delivery-service providers, considering factors such as their proximity to orders, current workloads, and the specifications of their vehicles.

In one or more embodiments, the assigning module 216 is configured to receive real-time delivery updates, and track fulfilment progress to dynamically reassign incomplete deliveries based on compatibility scores. As deliveries progress, the assigning module 216 continuously monitors updates, such as changes in the status of individual orders, delays, or issues encountered by delivery-service providers.

The method and system is advantageous in a manner that it significantly enhances the efficiency of last mile delivery by dynamically leveraging crowd sourced delivery-service providers. By allowing customers to act as delivery-service providers and dynamically determining delivery regions, the method reduces reliance on traditional delivery resources and optimizes delivery routes based on real time demand, vehicle suitability, and product compatibility. This ensures that fragile or specialized products are handled by appropriate vehicles, improving delivery safety and efficiency.

The method and system is further advantageous because it incorporates demand prediction capabilities that enable businesses to anticipate future orders and plan deliveries accordingly. This results in better resource allocation and reduced operational costs, as delivery regions are continuously optimized based on both current and forecasted order volumes. Additionally, product type and vehicle specifications are factored into the prediction model, ensuring that orders are consolidated and assigned to suitable delivery vehicles.

Another technical advancement of the method and system is its ability to support multiple delivery tours for a single delivery-service provider within a given time window, respecting the preferences of the delivery-service provider while ensuring efficient order fulfillment. This feature contrasts with prior systems that strictly follow static routes and fail to account for delivery-service provider specific limitations such as vehicle capacity and the suitability of vehicles for handling different product types, such as fragile or hazardous goods.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A computer-implemented method for last-mile delivery optimization, comprising:
maintaining, by a processor, a platform of crowd-sourced delivery-service providers, each delivery-service provider having registered vehicle specifications and delivery preferences including maximum delivery per trip;
receiving, by the processor, delivery orders within a predetermined time window;
dynamically determining, by the processor, delivery regions based on real-time factors of delivery orders;
determining, by the processor, compatibility scores by matching product handling requirements of the delivery orders with registered vehicle specifications;
generating, by the processor, multiple sequential delivery tours for individual delivery-service providers within the single time window based on delivery-service provider specified maximum deliveries per trip, the compatibility scores, and the dynamically determined delivery regions;
triggering, by the processor, delivery assignments to the selected delivery-service providers based on the generated delivery tours.

2. The method of claim 1, further comprising:
receiving a rejection response from a selected delivery-service provider;
identifying alternative delivery-service providers based on compatibility scores; and
reassigning rejected sequential delivery tours to maintain delivery schedules.

3. The method of claim 1, wherein each delivery-service provider specifies at least one delivery preference comprising available time slots, days of availability, maximum deliveries per trip, preferred delivery locations, and deliverable item characteristics including weight and product category.

4. The method of claim 1, wherein determining compatibility scores comprises matching product requirements including fragility, temperature sensitivity, and hazardous material indicators with vehicle capabilities including suspension characteristics, cargo space parameters, and temperature control features.

5. The method of claim 4, wherein determining compatibility scores comprises utilizing at least one of attribute matching techniques, semantic analysis, statistical models, and machine learning algorithms.

6. The method of claim 1, wherein generating multiple sequential delivery tours comprises:
evaluating consolidated delivery orders based on the compatibility scores;
dividing compatible delivery orders into sequential tours based on the delivery-service provider specified maximum deliveries per trip, or maximum weight per trip; and
scheduling subsequent tours after verifying completion of preceding delivery tours.

7. The method of claim 1, further comprising:
forecasting future delivery demand based on historical order data; and
dynamically adjusting delivery assignments based on current order density and delivery service-providers availability.

8. The method of claim 1, further comprising:
receiving real-time delivery updates;
tracking fulfillment progress; and
dynamically reassigning incomplete deliveries based on compatibility scores.

9. The method of claim 1, further comprising validating delivery-service provider performance based on at least one of adherence to product handling requirements and maintaining compatibility scores above a threshold.

10. The method of claim 1, wherein maintaining the platform comprises continuously updating vehicle specifications based on at least one of sensor data from delivery vehicles, and validated delivery performance.

11. The method of claim 1, further comprising:
managing delivery tour acceptance through mobile notifications; and
executing compatibility-based reassignment upon tour rejection.

12. The method of claim 1, further comprising:
predicting regional delivery demand for upcoming periods;
prioritizing immediate delivery orders while temporarily holding remaining delivery orders; and
consolidating the held delivery orders with future predicted demand.

13. The method of claim 12, wherein consolidating the held delivery orders comprises:
evaluating delivery-service provider availability data;
grouping delivery orders based on the dynamically determined delivery regions; and
optimizing consolidated delivery assignments based on the compatibility scores.

14. The method of claim 1, wherein dynamically determining delivery regions comprises:
receiving a current location of a delivery-service provider, wherein the current location;
generating a delivery region centered around the current location of the delivery-service provider independent of any fixed delivery routes;
determining a radius of the delivery region based on a quantity of delivery orders within the predetermined time window; and
modifying the radius of the delivery region upon changes in the quantity of delivery orders.

15. The method of claim 1, wherein generating multiple sequential delivery tours comprises:
determining a required number of sequential tours based on a total number of delivery orders and the delivery-service provider specified maximum deliveries per trip;
scheduling the sequential tours within the predetermined time window; and
verifying completion of a preceding tour before initiating a subsequent tour.

16. The method of claim 1, further comprising:
monitoring real-time changes in delivery order density within the dynamically determined delivery regions;
adjusting boundaries of the delivery regions based on the real-time changes; and
updating the multiple sequential delivery tours based on the adjusted delivery regions.

17. A system for dynamic last-mile delivery optimization, comprising:
a processor; and
a memory storing instructions that, when executed by the processor, cause the processor to:
maintain a platform of crowd-sourced delivery-service providers, each delivery-service provider having registered vehicle specifications and delivery preferences including maximum deliveries per trip;
receive delivery orders within a predetermined time window;
dynamically determine delivery regions based on the received delivery orders;
determine compatibility scores by matching product handling requirements of the delivery orders with registered vehicle specifications;
generate multiple sequential delivery tours for individual delivery-service providers within the single time window based on delivery-service provider specified maximum deliveries per trip, the compatibility scores, and the dynamically determined delivery regions; and
trigger delivery assignments to the selected delivery-service providers based on the generated delivery tours.

18. The system of claim 17, wherein the processor is further configured to:
receive a rejection response from a selected delivery-service provider;
identify alternative delivery-service providers based on compatibility scores; and
reassign rejected sequential delivery tours to maintain delivery schedules.

19. The system of claim 17, wherein each delivery-service provider specifies at least one delivery preference comprising available time slots, days of availability, maximum deliveries per trip, preferred delivery locations, and deliverable item characteristics including weight and product category.

20. The system of claim 17, wherein determining compatibility scores comprises matching product requirements including fragility, temperature sensitivity, and hazardous material indicators with vehicle specifications including suspension characteristics, cargo space parameters, and temperature control features.

21. The system of claim 20, wherein determining compatibility scores comprises utilizing at least one of attribute matching techniques, semantic analysis, statistical models, and machine learning algorithms.

22. The system of claim 17, wherein generating multiple sequential delivery tours comprises:
evaluating consolidated delivery orders based on the compatibility scores;
dividing compatible delivery orders into sequential tours based on the delivery-service provider specified maximum deliveries per trip; and
scheduling subsequent tours after verifying completion of preceding delivery tours.

23. The system of claim 17, wherein the processor is further configured to:
forecast future delivery demand based on historical order data; and
dynamically adjust delivery assignments based on current order density and delivery-service provider availability.

24. The system of claim 17, wherein the processor is further configured to:
receive real-time delivery updates;
track fulfillment progress; and
dynamically reassign incomplete deliveries based on compatibility scores.

25. The system of claim 17, wherein the processor is further configured to validate delivery-service provider performance based on at least one of adherence to product handling requirements and maintaining compatibility scores above a threshold.

26. The system of claim 17, wherein maintaining the platform comprises continuously updating vehicle specifications based on at least one of sensor data from delivery vehicles and validated delivery performance.

27. The system of claim 17, wherein the processor is further configured to:
manage delivery tour acceptance through mobile notifications; and
execute compatibility-based reassignment upon tour rejection.

28. The system of claim 17, wherein the processor is further configured to:
predict regional delivery demand for upcoming periods;
prioritize immediate delivery orders while temporarily holding remaining delivery orders; and
consolidate the held delivery orders with future predicted demand.

29. The system of claim 28, wherein consolidating the held delivery orders comprises:
evaluate delivery-service provider availability data;
group delivery orders based on the dynamically determined delivery regions; and
optimize consolidated delivery assignments based on the compatibility scores.

30. The system of claim 17, wherein dynamically determining delivery regions comprises:
identify a delivery-service provider specified location, wherein the delivery-service provider specified location comprises at least one of a home location, an office location, and a temporary location;
calculate a delivery area around the delivery-service provider specified location based on current order density; and
adjust the delivery area upon subsequent delivery triggers.

31. The system of claim 17, wherein generating multiple sequential delivery tours comprises:
determine a required number of sequential tours based on a total number of delivery orders and the delivery-service provider specified maximum deliveries per trip, or maximum weight per trip;
schedule the sequential tours within the predetermined time window; and
verify completion of a preceding tour before initiating a subsequent tour.

32. The system of claim 17, wherein the processor is further configured to:
monitor real-time changes in delivery order density within the dynamically determined delivery regions;
adjust boundaries of the delivery regions based on the real-time changes; and
update the multiple sequential delivery tours based on the adjusted delivery regions.
